(19) United States
(12) Patent Application Publication
(10) Pub. No.: US 2009/0271161 A1
(43) Pub. Date: Oct. 29, 2009

(54) ARRANGEMENT OF CUTTING ELEMENTS ON ROLLER CONES FOR EARTH BORING BITS

(75) Inventor: Gregory L. Ricks, Spring, TX (US)

Correspondence Address: Bracewell & Giuliani LLP, P.O. Box 61389, Houston, TX, 77208-1389, US

(73) Assignee: BAKER HUGHES INCORPORATED, Houston, TX (US)

(21) Appl. No.: 12/109,953

(22) Filed: Apr. 25, 2008

(51) Int. Cl. G06F 17/50

(52) U.S. Cl. 703/7

(57) ABSTRACT

A method for determining an optimized arrangement of cutting elements about a roller cone bit is provided. Also provided is a roller cone drill bit having cutting elements that are arranged according to a computerized optimization routine.

### BACKGROUND OF THE INVENTION

1. Field of the Invention

The present invention relates generally to drill bits for drilling boreholes into subterranean formations. More specifically, the invention relates to methods for designing drill bits and optimizing the arrangement of cutting elements on a drill bit.

2. Description of Related Art

One example of a conventional prior art drill bit is shown in FIG. 1. This type of drill bit is typically referred to as a roller cone drill bit. The drill bit 100 includes a bit body 102 having a threaded section 104 at its upper end for securing to the drill string (not shown) and a plurality of legs 106 extending downwardly at its lower end. A conical roller cone 108 is rotatably mounted on each leg 106 by a bearing shaft pin which extends downwardly and inwardly from each leg. Each of the roller cones 108 has a cutting structure comprising a plurality of cutting elements 110 arranged on the conical surface of the cones 108. The cutting elements 110 project from the cone body and act to contact and break up earth formations at the bottom of the borehole when the bit 100 is rotated under an applied axial load. The cutting elements 110 may comprise teeth formed on the conical surface of the cone 108 (typically referred to as milled steel teeth) or inserts press-fitted into holes in the conical surface of the cone 108 (such as tungsten carbide inserts or polycrystalline diamond cutting elements).

Prior art methods for determining the placement of the cutting elements on roller cone drill bits have included computer aided methods, as well as relying upon the experience of senior engineers to decide upon the preferred placement of cutting elements about the drill bit. Computer aided methods have for example involved complex calculations to simulate a bottom hole hit pattern for the cutting elements on a roller cone drill bit. However, none of the prior art methods have employed a simplex optimization routine to calculate an optimized arrangement of cutting elements about the surface of the cone. Additionally, no methods have previously been provided to determine an optimized placement of cutting elements on cones having variable spacing of the cutting elements within individual rows. Thus, a need exists for such a method.

### SUMMARY OF THE INVENTION

The present invention relates generally to drill bits for drilling boreholes. More specifically, provided are methods for optimizing the placement of cutting elements on roller cones, leading to increased rate of penetration and increased durability of cones prepared according to the methods described herein.

In one aspect, a method for designing a roller cone drill bit having an optimized arrangement of cutting elements on a roller cone is provided. The method includes the steps of inputting parameters for the number of rows of cutting elements and the number of cutting elements in each row on the roller cone, defining an initial start position for the placement of the cutting elements for each row of the roller cone and calculating a score for an initial arrangement of cutting elements about the roller cone. The starting position of the cutting elements about the roller cone is then adjusted relative to the initial start position. A score is calculated for the adjusted placement of the cutting elements about the roller cone. The score for the adjusted placement of the cutting elements about the roller cone is then compared against the score for the initial arrangement to determine if the score is within an acceptable range. Optionally, the steps of adjusting the starting position of cutting elements about the roller cone and calculating a score are repeated.

In certain embodiments, the score is calculated against an idealized even distribution of cutting elements about the roller cone using the following formula:

$${\sum }_{i = 1}^{n} \vert [ ai ] - ( i - 1 ) \frac{360}{n} \vert$$

wherein ai is the i′th cutting element angle and n is the total number of cutting elements.

In certain embodiments, the method further includes inputting the spacing of cutting elements in each row. In certain other embodiments, the method further includes calculating the idealized spacing of cutting elements within each row. In certain embodiments, the orientation of the cutting elements in a row is maintained constant. In certain other embodiments, the method includes the step of defining an initial start position for placement of cutting elements includes selecting a starting cutting element in each row of the roller cone and aligning the starting cutting elements of each row at an initial starting angle.

In another aspect, a roller cone drill bit having an optimized arrangement of cutting elements about the roller cone is provided. The drill bit includes a body, at least one leg, a cantilevered bearing shaft and at least one roller cone, wherein the bearing shaft defines a longitudinal axis and includes a base secured to the at least one leg. The roller cone is disposed about the bearing shaft for rotation about a longitudinal axis and includes a plurality of cutting elements spaced apart and generally about a conical surface of at least one of the roller cones. The cutting elements are arranged about the surface of the roller cone according to an optimized arrangement, wherein the optimized arrangement includes a predetermined number of rows of cutting elements and is determined by the following steps: (a) inputting parameters for the number of rows of cutting elements and the number of cutting elements in each row on the roller cone; (b) defining an initial start position for the placement of the cutting elements for each row of the roller cone; (c) calculating a score for an initial arrangement of cutting elements about the roller cone; (d) adjusting the starting position of the cutting elements about the roller cone; (e) calculating a score for the adjusted placement of the cutting element about the roller cone; (f) comparing the score in step (c) with the score in step (e) and determining if the score is within an acceptable predetermined range of an ideal placement of cutting elements about a roller cone; and (g) optionally repeating steps (d) and (e) until the score is within the acceptable predetermined range. In certain embodiments, the score is calculated against an idealized even distribution of cutting elements about the roller cone using the following formula:

$${\sum }_{i = 1}^{n} \vert [ ai ] - ( i - 1 ) \frac{360}{n} \vert$$

wherein ai is the i′th cutting element angle and n is the total number of cutting elements.

### BRIEF DESCRIPTION OF THE DRAWINGS

FIG. 1 is a view of a prior art roller cone drill bit.

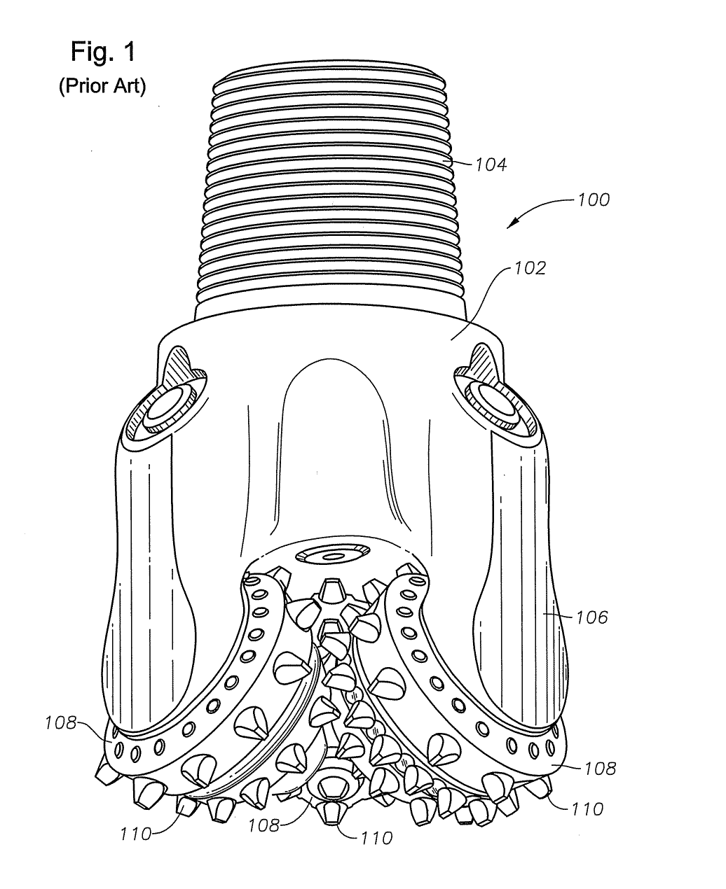

FIG. 2 is a flow chart of a method in accordance with one embodiment of the present invention for the arrangement of cutting elements on a roller cone.

FIG. 3 is a view of a roller cone, illustrating placement of the cutting elements on the roller cone according to one embodiment of the present invention.

### DETAILED DESCRIPTION

Although the following detailed description contains many specific details for purposes of illustration, one of ordinary skill in the art will appreciate that many variations and alterations to the following details are within the scope and spirit of the invention. Accordingly, the exemplary embodiments of the invention described herein are set forth without any loss of generality to, and without imposing limitations thereon, the present invention.

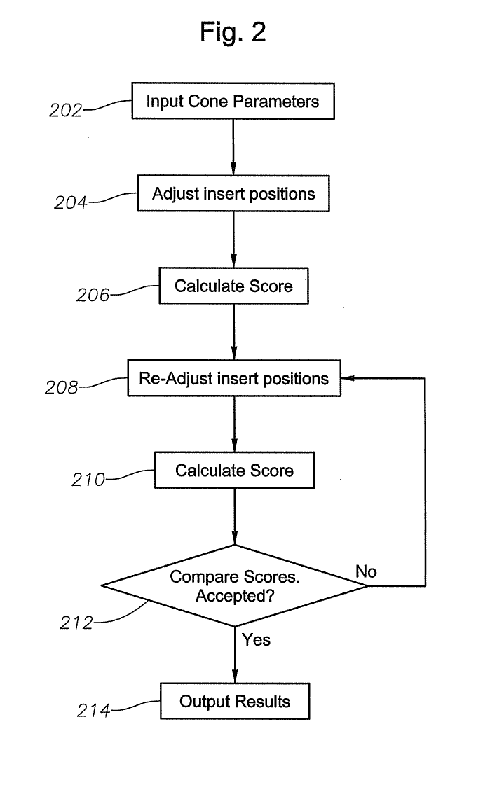

Referring to FIG. 2, in one aspect, a method is provided for optimizing the arrangement of cutting elements on a roller cone. In a first step 202, parameters for the cone are selected and input into a computer or like apparatus, which has been configured to provide mathematical calculations. The parameters which are selected can include the number of rows of cutting elements on the cone, the number of cutting elements to be placed in each row, and the spacing interval for the cutting elements in each row, and combinations thereof, although other parameters such as the pitch of the cutting element can also be selected and input into the computer. In certain embodiments, the number of rows and the number of cutting elements can be input into the computer. In certain other embodiments, the number of rows of cutting elements and the spacing of cutting elements can be input into the computer. A traditional database can be used for both inputting the parameters, as well as for outputting the optimized arrangement of cutting elements about the roller con

Once the initial parameters have been input into the computer or like device, in second step 204, a simplex optimization routine is performed to determine an adjusted spacing arrangement of the individual rows. Simplex optimization routines are known algorithms that calculate the vector of parameters corresponding to a global extreme (maximum or minimum) of any n-dimensional function F(x₁, x₂, xₙ) by searching through the parameter space (also referred to as a search area). In running the simplex optimization routine, the location of the first row of cutting elements is maintained constant throughout the process. The simplex optimization routine then determines how each row is to be adjusted relative to the first row.

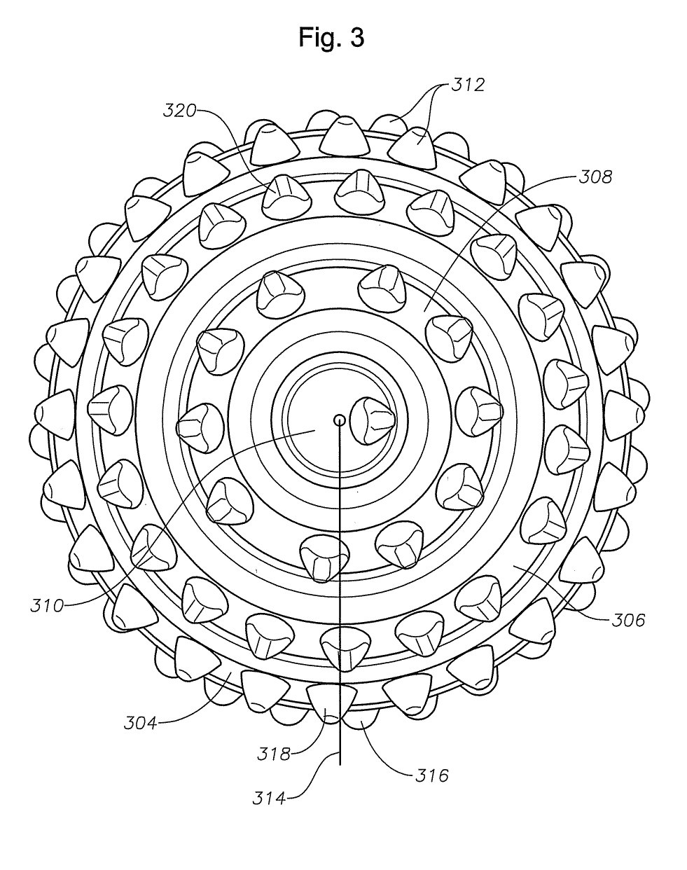

The optimization program begins by selecting a zero point in the first row of cutting elements on the cone. The zero point of the cone is shown in FIG. 3 as item 314. The zero point is arbitrary and can be any point along the cone however once the zero point has been selected, it remains fixed in place throughout the optimization routine. It is against the zero point 314 that the relative displacement of each subsequent row of cutting elements is compared against during optimization of the arrangement of cutting elements on the cone.

The first row 302 of cutting elements, as shown in FIG. 3, is the row located at the heel of the cone. The second row 304 of cutting elements is adjacent the first row 302. The third row 306, the fourth row 308 and the fifth row 310 are all arranged in sequential order of their relative displacement from the first row 302.

A starting point can be defined for each row of cutting elements. In certain embodiments, the starting points for each row of compacts can be different and not aligned at the same angle. In other embodiments, the starting points for each row of compacts can be randomized.

In yet other embodiments, a zero point in the first row 302 can be aligned along a zero degree orientation. As shown in FIG. 3, the zero point of the first row 302 corresponds to cutting element 316. As noted previously, the location of the first row 302 may be kept constant throughout the simplex optimization routine. Thus, starting cutting element 316 of the first row 302 will stay aligned with the zero point 314 throughout the simplex optimization routine. The starting point for each additional row on the cone, i.e., rows 2-5 for the cone illustrated in FIG. 3, can then be selected. For example, the first cutting element 318 in the second row 304 is approximately aligned with the zero point 314. Similarly, the first cutting element 320 in the third row 306 is approximately aligned with the zero point 314. In an alternate embodiment, the starting cutting element in each row is exactly aligned with the starting cutting element 316 of the first row.

In certain embodiments, the spacing within a row is maintained constant. In certain embodiments, the spacing of the cutting elements within a given row is variable and the starting point for that row having variable spacing is preferably selected as the starting point of a repeating spacing pattern.

In a third step 206, a score is calculated for the arrangement of cutting elements about the surface of the roller cone. In determining the score, the simplex optimization routine examines each individual cutting element as placed about the surface of the drilling cone and compares the location against an idealized even spacing of the cutting elements about the cone. The idealized even spacing is calculated by dividing 360° by the total number of cutting elements placed about the surface of the cone. The idealized even spacing of cutting elements is relative to the entire surface of the cone, and is not provided in terms of an idealized spacing for an individual row. Thus, as an example, for a cone having 100 cutting elements, the idealized spacing for the entire cone provides a cutting element at 3.6° intervals. Put differently, the first cutting element is at the zero point (i.e., 0°). The second cutting element is at 3.6°, the third cutting element is at 7.2°, and so on. As noted previously, this spacing scheme only takes into account the presence of a cutting element relative to the zero point against which the location is measured, and does not specifically take into account the row in which that cutting element is located.

The score is calculated by comparing the position of the cutting elements against the idealized evenly spaced arrangement of cutting elements. Specifically, in certain embodiments, the sum of the absolute value of the difference between the initial spacing and the idealized even spacing is calculated and provided as the score. The lower the score for a particular arrangement of cutting elements on the cone, the closer to the idealized evenly spaced arrangement of the cutting elements for that particular arrangement. Thus, the lowest score is desired. The score for a particular arrangement can then be compared against previous and subsequent arrangements of the cutting elements about the roller cone.

In a fourth step 208, the position of the cutting elements is adjusted according to the simplex optimization routine to preferably obtain a lower score. The simplex optimization routine then calculates the adjustment for each starting cutting element for each row of cutting elements (other than the first row) relative to the zero point.

In a fifth step 210, a score is calculated for the adjusted cone arrangement. The score is calculated as previously described with respect to step 206, wherein the position of each cone on the adjusted cone arrangement is compared against the idealized evenly spaced cone arrangement. The sum of the absolute value of the various differences is the score for that particular adjusted arrangement.

In a sixth step 212, in certain embodiments, the score of the adjusted cone arrangement determined in step 208 is compared against a maximum allowed score. The maximum allowed score can be preselected by the cone designer. If the score in step 212 is less than the maximum allowed score, then the parameters for that arrangement can be output and provided to a design team. If the score of the adjusted cone arrangement is greater than the predetermined maximum allowed score, then steps 208, 210 and 212 can be repeated. The steps 208, 210 and 212 can be repeated until an arrangement having a score below the maximum allowed score is provided, or optionally until a maximum number of trials have been run without providing a score that is less than the maximum allowed score.

As is known in the art, the cutting elements can be a variety of materials. For example, the cutting elements can be steel teeth, tungsten carbide inserts, or other known materials having a hardness or durability suitable for drilling operations.

Similarly, individual cutting elements are placed within rows according to a predetermined spacing or pitch scheme, or a combination thereof. In one embodiment, each row has a starting angle from which a pitch pattern initiates. In another embodiment, the cutting elements are spaced about the cone to achieve a completely random distribution of the cutting elements about the cone, wherein each cone has a random pitch. In certain embodiments, each row has a constant pitch for all cutting elements. In yet other embodiments, the pitch of the cutting elements in a row is variable and can be calculated by computational means, as is known in the art.

In one aspect, the methods described herein can be used to prepare drill bits that exhibit increased durability and increased rate of penetration. Without wishing to be bound by a specific theory, the increased performance of the drill bit is believed to partially be a result of the optimized placement of cutting elements and pitch patterns, which results in a higher number of cutting elements projecting outward and into the formation about the surface of the roller cone drill bit.

An even distribution of cutting elements is also believed to reduce over-exposure of any single cutting element or groups of cutting elements on the surface of the cone, wherein a single cutting element or group of cutting elements that are over-exposed cutting element is, by virtue of its orientation and placement on the cone relative to other cutting elements, such that the cutting element or group of cutting elements contacts the subterranean surface at a greater rate or with greater force than the other cutting elements on the surface of the cone, thereby potentially leading to increased wear and increased failure for that cutting element or group of cutting elements.

A variety of parameters can be adjusted and input to calculate an idealized arrangement of cutting elements on the roller cone surface, including, but not limited to, the number of rows of cutting elements on a given drilling cone, number of cutting elements with each individual row, the spacing of the cutting elements within each individual row, and the pitch of the individual cutting elements within a row.

In certain embodiments, computational methods for determining the spacing of cutting elements within a row can be incorporated with the methods disclosed herein for the selection of cutting elements on the roller cone drill bit.

In certain embodiments, a bottom hole hit pattern can be determined for an individual cutting element arrangement on the cone to simulate the performance of the design. Thus, in certain embodiments, the present method for optimizing the arrangement of cutting elements about the cone can be coupled with computer simulation methods, including methods for simulating and evaluating bottom hole hit patterns.

As used herein, recitation of the term about and approximately with respect to a range of values should be interpreted to include both the upper and lower end of the recited range.

As used in the specification and claims, the singular form “a”, “an” and “the” may include plural references, unless the context clearly dictates the singular form.

Although some embodiments of the present invention have been described in detail, it should be understood that various changes, substitutions, and alterations can be made hereupon without departing from the principle and scope of the invention.

1. A method for designing a roller cone drill bit having an optimized arrangement of cutting elements on a roller cone, comprising:
(a) inputting parameters for the number of rows of cutting elements and the number of cutting elements in each row on the roller cone;
(b) defining an initial start position for the placement of the cutting elements for each row of the roller cone;
(c) calculating a score for an initial arrangement of cutting elements about the roller cone;
(d) adjusting the start position of the cutting elements about the roller cone to define an adjusted placement of the cutting elements about the roller cone;
(e) calculating a score for the adjusted placement of the cutting elements about the roller cone;
(f) comparing the score in step (c) with the score in step (e) and determining if the score in is within an acceptable predetermined range of an ideal placement of cutting elements about a roller cone; and
(g) optionally repeating steps (d) and (e) until the score is within the acceptable predetermined range.

2. The method of claim 1, further comprising inputting a spacing of cutting elements in each row.

3. The method of claim 1, further comprising calculating an idealized spacing of cutting elements within each row.

4. The method of claim 1 wherein an orientation of the cutting elements in a row is maintained constant.

5. The method of claim 1 wherein the step of defining an initial start position for the placement of cutting elements comprises selecting a starting cutting element in each row of the roller cone and aligning the starting cutting elements of each row at an initial starting angle from each other.

6. The method of claim 1 wherein a spacing between adjacent cutting elements within at least one row is constant.

7. The method of claim 1 wherein a spacing between adjacent cutting elements within at least one row is variable.

8. The method of claim 1 further comprising calculating the score against an idealized even distribution of cutting elements about the roller cone using the following formula:
$${\sum }_{i = 1}^{n} \vert [ ai ] - ( i - 1 ) \frac{360}{n} \vert$$
wherein ai is the i′th cutting element angle and n is the total number of cutting elements.

9. A method for designing a roller cone bit having a body, at least one leg, at least one cantilevered bearing shaft and at least one roller cone mounted thereon containing a plurality cutting elements, the method comprising:
(a) inputting parameters for the number of rows of cutting elements, the spacing of cutting elements in each row, and the number of cutting elements in each row on the roller cone;
(b) defining an initial start position for the placement of the cutting elements for each row of the roller cone;
(c) calculating a score for an initial arrangement of cutting elements about the roller cone;
(d) adjusting the start position of each row of cutting elements about the roller cone to define an adjusted placement of cutting elements about the roller cone;
(e) calculating a score for the adjusted placement of the cutting element about the roller cone;
(f) comparing the score in step (c) with the score in step (e) and determining if the score in is within an acceptable predetermined range of an ideal placement of cutting elements about a roller cone; and
(g) optionally repeating steps (d) and (e) until the score is within the acceptable predetermined range.

10. The method of claim 9, wherein the steps for determining the optimized arrangement of cutting elements further comprises calculating an idealized spacing of cutting elements within each row.

11. The method of claim 9 wherein the spacing of the cutting elements in at least one row is maintained constant.

12. The method of claim 9 wherein the step of defining an initial start position for placement of cutting elements comprises selecting a starting cutting element in each row of the roller cone and aligning the starting cutting elements of each row at an initial starting angle from each other.

13. The method of claim 9 wherein the spacing between adjacent cutting elements within a row is constant.

14. The method of claim 9 wherein the spacing between adjacent cutting elements within a row is variable.

15. The method of claim 9 further comprising calculating the score against an idealized even distribution of cutting elements about the roller cone using the following formula:
$${\sum }_{i = 1}^{n} \vert [ ai ] - ( i - 1 ) \frac{360}{n} \vert$$
wherein ai is the i′th cutting element angle and n is the total number of cutting elements.

16. A method for designing a roller cone drill bit having an optimized arrangement of cutting elements on a roller cone, comprising:
(a) inputting parameters for the number of rows of cutting elements on the roller cone, the number of cutting elements in each row on the roller cone, and the spacing between adjacent cutting elements in each row, wherein the spacing between adjacent cutting elements for at least one row is constant;
(b) defining an initial start position for the placement of the cutting elements for each row of the roller cone;
(c) evaluating an initial arrangement of cutting elements about the roller cone by calculating a score associated with the initial arrangement;
(d) adjusting the start position of each row of cutting elements about the roller cone to define an adjusted placement of cutting elements about the roller cone;
(e) evalutating the adjusted placement of the cutting element about the roller cone by calculating a score associated with the adjusted placement;
(f) comparing the score in step (c) with the score in step (e) and determining if the score is within an acceptable predetermined range of an ideal placement of cutting elements about a roller cone; and
(g) optionally repeating steps (d), (e) and (f) until the score associated with the placement of cutting elements about the roller cone is within the acceptable predetermined range.

17. The method of claim 16 wherein the spacing between adjacent cutting elements in a row is constant.

18. The method of claim 16 wherein the spacing between adjacent cutting elements in a row is variable.

19. The method of claim 16 further comprising calculating the score against an idealized even distribution of cutting elements about the roller cone using the following formula:
$${\sum }_{i = 1}^{n} \vert [ ai ] - ( i - 1 ) \frac{360}{n} \vert$$
wherein ai is the i′th cutting element angle and n is the total number of cutting elements.
